(19) United States
(12) Patent Application Publication
(10) Pub. No.: US 2019/0164072 A1
(43) Pub. Date: May 30, 2019

(54) INFERENCE SYSTEM, INFORMATION PROCESSING SYSTEM, INFERENCE METHOD, AND RECORDING MEDIUM

(71) Applicant: NEC Corporation, Tokyo (JP)

(72) Inventors: Kentarou SASAKI, Tokyo (JP); Daniel Georg ANDRADE SILVA, Tokyo (JP); Yotaro WATANABE, Tokyo (JP); Kunihiko SADAMASA, Tokyo (JP)

(73) Assignee: NEC Corporation, Tokyo (JP)

(21) Appl. No.: 16/322,593

(22) PCT Filed: Aug. 2, 2016
(86) PCT No.: PCT/JP2016/003541

§ 371 Date: Feb. 1, 2019

(51) Int. Cl. G06N 5/04

(52) U.S. Cl. CPC G06N 5/046; G06N 5/048

(57) ABSTRACT

An inference system according to the present invention relates to inference from a starting state and a first rule set to an ending state. The inference system includes: a memory; and at least one processor coupled to the memory. The processor performs operations. The operations includes: receiving a parameter for use in selecting a second rule set from the first rule set; and visualizing the second rule set associated with the parameter.

### TECHNICAL FIELD

The present invention relates to an inference system, an information processing system, an inference method, and a recording medium that output information related to inference.

### BACKGROUND ART

There is a system that executes inference from a set of logical expressions (hereinafter, referred to as “rules”), based on a predetermined regulation or criterion. The system as described above is called an inference system (refer to PTL 1 and NPL 1, for example). The inference system is visually expressed by using a directed graph, an undirected graph, or the like (refer to PTL 2, for example).

An early inference system has used only a logical expression as a determination criterion. However, in recent years, an inference system using not only a definite determination criterion such as a logical expression but also a probabilistic determination criterion has been usable.

The probabilistic inference system as described above defines a random variable, based on a rule set, and executes probabilistic logical inference. For example, the inference system receives an observation and a query as inputs, and, from the observation and the rule set, calculates a posterior probability being a probability in which the query is established.

As such an inference method, there are, for example, Probabilistic Soft Logic (PSL; refer to NPL 2, for example) and Markov Logic Network (MLN; refer to NPL 3, for example).

### CITATION LIST

### Patent Literature

[PTL 1] International Publication WO2015/145555

[PTL 2] Japanese Unexamined Patent Application Publication No. H09(1997)-204309

### Non Patent Literature

[NPL 1] Lise Getoor and Ben Taskar, “Introduction to Statistical Relational Learning (Adaptive Computation and Machine Learning Series)”, The MIT Press, Aug. 31, 2007, pp. 291-322, (Kristian Kersting and Luc De Raedt. “10 Bayesian logic programming: Theory and tool”)

[NPL 2] Angelika Kimmig, Stephen H. Bach, Matthias Broecheler, Bert Huang, and Lise Getoor, “A short introduction to probabilistic soft logic”, NIPS Workshop on Probabilistic Programming: Foundations and Applications, edition: 2, Location: Lake Tahoe, Nev., USA, Dec. 7-8, 2012.

[NPL 3] Matthew Richardson and Pedro Domingos, “Markov logic networks. Machine learning”, Machine Learning, Volume 62, Issue 1, p.p. 107-136, February, 2006 (First Online, Jan. 27, 2006), Publisher: Kluwer Academic Publishers.

### SUMMARY OF INVENTION

### Technical Problem

Technologies described in NPLs 1 to 3 calculate, based on a rule set, an input observation, and an input query, a posterior probability in which the query is established from the observation and the rule set.

Hereinafter, “the posterior probability in which a query is established from an observation and a rule set” is referred to as “an inference result”.

The technologies described in NPLs 1 to 3 can output a calculated inference result. However, the technologies described in NPLs 1 to 3 do not output how the inference result, which is a posterior probability in which a query is established from a rule set and an observation, is calculated. In other words, the technologies do not output an inference process or a reason (cause) of reaching the inference result.

However, the inventor of the present invention has found that there is a case in which it is desirable that, in a scene in which an inference system is used, the inference system present not only an inference result but also an inference process or a reason of reaching the inference result.

For example, a case in which a user of an inference system uses the inference system for supporting self-decision-making is assumed. In this case, for the user, rather than a decision-making using only an inference result calculated by the inference system, a decision-making using an inference process or a reason of reaching the inference result in addition to the inference result becomes a decision-making based on a deeper insight. For example, based on the inference process or the reason of reaching the inference result, the user can determine how reliable the inference result is.

As described above, when a user of the inference system can grasp an inference process or a reason of reaching the inference result, the user can increase knowledge about the inference result. This is knowledge acquired by the inventor of the present invention.

However, an internal model and an operation process used for an inference system are enormous and poor in interpretability in most cases. For example, in a case of the MLN, all rules appearing in a coupled network including the observation and the query affect the inference result. Moreover, as a contribution for probability of the inference result, the respective rules relate to one another via complicated equations (refer to NPL 3, for example). Therefore, when extracting “a rule set for use in inference”, for example, an extracted rule set becomes a rule set including all rules appearing in the coupled network including the observation and the query.

Furthermore, rules for use by the probabilistic inference system include many rules from a rule that largely affects the result to a rule that hardly affects the result. Therefore, when extracting “the rule set for use in inference”, for example, the extracted rule set becomes a redundant rule set including a rule that hardly affects the result. Therefore, a user cannot grasp which rule is a rule that largely affects the result in the inference process or the reason of reaching the inference result in the extracted rule set. In other words, when using the whole of the extracted rule set, the user cannot grasp the inference process or the reason of reaching the inference result.

As described above, NPLs 1 to 3 have an issue that it is difficult to present an inference process or a reason of reaching an inference result.

Inventions described in PTLs 1 and 2 do not solve the above-described issue, either.

An object of the present invention is to solve the above-described issue, and to provide an inference system, an information processing system, an inference method, and a recording medium that present an inference process or a reason.

### Solution to Problem

An inference system according to one aspect of the present invention relates to inference from a starting state and a first rule set to an ending state. The inference system includes: receiving means for receiving a parameter for use in selecting a second rule set from the first rule set; and visualizing means for visualizing the second rule set associated with the parameter.

An information processing system according to one aspect of the present invention includes: the above-mentioned inference system; and optimizing means for selecting the second rule set as a solution of a predetermined optimization problem, based on the parameter.

An inference method according to one aspect of the present invention is a method for an inference system related to inference from a starting state and a first rule set to an ending state. The inference method includes: receiving a parameter for use in selecting a second rule set from the first rule set; and visualizing the second rule set associated with the parameter.

A recording medium according to one aspect of the present invention is a medium for an inference system related to inference from a starting state and a first rule set to an ending state. The recording medium computer-readably records a program causing a computer to execute: processing of receiving a parameter for use in selecting a second rule set from the first rule set; and processing of visualizing the second rule set associated with the parameter.

### Advantageous Effects of Invention

According to the present invention, effects of presenting an inference process or a reason can be exerted.

### BRIEF DESCRIPTION OF DRAWINGS

FIG. 1 is a block diagram illustrating an example of a configuration of an inference system according to a first example embodiment.

FIG. 2 is a diagram illustrating a first example of a rule set.

FIG. 3 is a diagram illustrating an example of a rule subset for a predetermined parameter.

FIG. 4 is a diagram illustrating an example of a rule subset for a parameter different from that in FIG. 3.

FIG. 5 is a view illustrating an example of visualization of the rule set.

FIG. 6 is a view illustrating an example of visualization in a case of a predetermined parameter value.

FIG. 7 is a diagram illustrating a second example of the rule set.

FIG. 8 is a diagram illustrating an example of a rule subset for a predetermined parameter in the second example of the rule set.

FIG. 9 is a diagram illustrating an example of a rule to be added to the second example of the rule set.

FIG. 10 is a diagram illustrating a third example of the rule set for explaining another visualization.

FIG. 11 is a diagram illustrating an example of visualization dealing with a plurality of parameters.

FIG. 12 is a flowchart illustrating an example of operations of the inference system according to the first example embodiment.

FIG. 13 is a block diagram illustrating an example of an information processing system including the inference system.

FIG. 14 is a block diagram illustrating a configuration of an information processing apparatus that is an example of a configuration of hardware according to the inference system.

### EXAMPLE EMBODIMENT

Next, example embodiments of the present invention will be described with reference to the drawing.

Note that the respective drawings are for describing the example embodiments of the present invention. However, the present invention is not limited to the description referring to the respective drawings. Moreover, the same reference numerals are assigned to similar constituents between the respective drawings, and, in some cases, repeated descriptions thereof are omitted. Moreover, in the drawings for use in the following description, in some cases, a description of constituents of portions which do not relate to the description of the present invention is omitted, and the constituents are not illustrated.

### [Explanation of Terms]

First, terms for use in describing the present example embodiments will be listed and defined.

“Atom” is a logical expression (an atomic formula or a prime formula) that does not have a sub formula. An example of the atom is a proposition variable or a predicate. In the following description, the predicate is mainly used as an example of the atom. For example, an example of the atom is “X smokes” when X is a variable. Note that there is also a case in which the atom is expressed by using a functional form. For example, the above-described “X smokes” may be expressed as “Smokes (X)”. Note that the atom may include a plurality of variables. For example, an example of the atom in this case is “X and Y are friends”. Note that, when the functional form is used, for example, “X and Y are friends” becomes “Friends (X, Y)”.

“Ground atom” is an atom in which a constant is assigned to the variable in the atom. For example, an atom in which a specific person is assigned to the variable X in the above-described “X smokes” is the ground atom. Specifically, for example, the ground atom, when a person Bob is assigned to the variable X, is “Bob smokes”. A true value (True (1) or False (0)) can be assigned to the ground atom. When Bob smokes, this ground atom becomes True. When Bob does not smoke, this ground atom becomes False.

“Rule” is a logical expression, and generally, a logical expression including the above-described atom. The rule for use in the following description is a rule of a predicate logic. Hence, the rule includes a predicate. In other words, the rule is described by using a proposition, a predicate, a constant, a variable, and a logic symbol (∀, ∃, ¬, ∧, ∨, →, ←, or ⇔). The rule used by the example embodiments in the present invention is given a score to be described later. Note that the following description will be given by using a rule of a first-order predicate logic for convenience of explanation. However, the present invention is not limited to the first-order predicate logic.

Note that the logic symbols described above are symbols for use in a general predicate logic, and meanings of the logic symbols are as follows.

“∀” is a logic symbol that means “regarding any . . . ” or “regarding all . . . ”. “∀” is called a universal quantifier, a universal quantification symbol, or a universal symbol.

“∃” is a logic symbol that means “there is a . . . that satisfies (a condition)” or “for a certain . . . ”. “∃” is called an existential symbol, a special symbol, or an existential quantification symbol.

“¬” is a logic symbol that represents a denial.

“∧” is a logic symbol that represents a conjunction or a logical product.

“∨” is a logic symbol that represents a disjunction or a logical sum.

“→” is a logic symbol that represents an implication. For example, “A→B” means “If A, then B”. “A→B” is the same value as “¬A∨B”.

“←” is a logic symbol that represents a logic in a direction opposite to “→”. For example, “A←B” means “If B, then A”.

“⇔” is a logic symbol that represents the same value. “A⇔B” is “(A→B)∧(A←B).”

Note that, in the following description, a rule including two or three atoms (A∧B→C, for example) is used as the rule. However, this is for convenience of explanation. Each of the example embodiments may use a rule including four or more atoms.

“Observation” indicates that a true value is assigned to one or plural ground atoms. In other words, an observation is a set composed of pairs of the ground atom and true value thereof. As described above, the true value is assigned to the ground atom included in the observation. In other words, the true value is determined for the ground atom included in the observation.

“Making an observation” indicates an operation of acquiring the ground atom to which the true value are assigned. Note that a transmission source of the observation in each of the example embodiments is not particularly limited. For example, each of the example embodiments may receive the observation from a user, or may receive the observation from a device or an instrument, each of which is not illustrated, such as a sensor.

“Query” indicates a ground atom that serves as an object from which a posterior probability is to be calculated from the observation and the rule set, or a logical combination of such ground atoms. In other words, the query is a set including, as an element, at least one ground atom or the logical combination of the ground atoms. Moreover, the query is an object of inference. Note that a transmission source of the query in each of the example embodiments is not particularly limited. For example, each of the example embodiments may receive the query from the user directly or indirectly.

Note that “starting state” described in Claims is equivalent to the observation. Moreover, “ending state” described in Claims is equivalent to the query.

“Score” is a value given to a rule based on a predetermined regulation. The score is information indicating an extent to which the rule is related to an inference process or a reason. However, the score for use in each of the example embodiments is not particularly limited. For example, the score may be a numerical value that represents a magnitude of an influence given by the rule to a result of the inference. Alternatively, the score may be a reliability of the rule. Here, the reliability of the rule is a score for use in MLN, for example.

Alternatively, the score may be a comparison result (a difference, a variation, or a ratio, for example) between a probability at which the query is established from an observation in a rule set including the rule and a probability at which the query is established from an observation in a rule set excluding the rule.

Alternatively, the score may be the number of rules included in the rule set.

Note that the score is defined to be preset in the description of each of the example embodiments. However, each of the example embodiments is not limited to this. For example, an inference system 100 to be described later may calculate the score of the rule before processing of visualization.

Note that the score may be set not only to the rule but also a set including a plurality of the rules (hereinafter, the set will be referred to as “rule subset”). For example, the score of the rule subset may be a sum of scores of rules included in the rule subset. Alternatively, the score of the rule subset may be a difference between the above-described probability in the whole of the rules (hereinafter, referred to as “rule set”) and the above-described probability in a case of excluding the rule subset from the rule set. Alternatively, the score of the rule subset may be a difference between the above-described probabilities in a case of excluding rules other than the rule subset from the rule set. As described above, a method of giving the score is not particularly limited. However, a method of generating the rule subset is not limited to the case of excluding the rule from the rule set. The rule subset may be a set of rules selected from the rule set based on a predetermined parameter. In other words, the exclusion of the rules is an example of processing for selecting the rule subset from the rule set. However, the following description will be given by taking the exclusion of the rule as an example.

Note that there is also a case in which the number of rules included in the rule subset is one. Hence, in the following description, the rule subset is defined to include a case of a single rule.

### [Explanation of Symbols]

Next, symbols for use in the following description will be explained.

“Function Card(S)” is a function that represents the number of elements of a set S that serves as an argument.

“Rule F” is a grounded rule, that is, a rule in which a value of a variable is determined.

“Rule set L” is a rule set of a whole of the rule F (hereinafter, the rule set L will be referred to as a first rule set).

“Rule subset L′” is a subset of the rule set L that is a remainder after excluding one or plural rules F from the rule subset L (hereinafter, the subset L′ will be referred to as a second rule set).

“Rule subset L″” is a subset of the one or plural rules F excluded as described above (third rule set).

A relationship between the rule set L, the rule subset L′ and the rule subset L″ is as follows.

L′⊆L, L″⊆L, L′∪L″=L, L′∩L″=φ

“Observation O” is a set of pairs of the ground atom and the true value thereof. In the following description, the observation O is defined not to be an empty set.

“Query Q” is a set including at least one ground atom or a logical combination of the ground atoms.

“Probability P(Q|O, L)” is a probability at which the query Q is established from the rule set L and the observation O. A probability at which the query Q is established from the rule subset L′ and the observation O is “probability P(Q|O, L′)”.

“Difference D_{L}(L′, O, Q)” is a difference (variation) between the probability P(Q|O, L′) at which the query Q is established from the observation O and the rule subset L′ and the probability P(Q|O, L) at which the query Q is established from the observation O and the rule set L. The difference D_{L}(L′, O, Q) becomes as follows when being expressed using an equation.

Difference D_{L}(L′, O, Q)=P(Q|O, L′)−P(Q|O, L)

In other words, the difference D_{L}(L′, O, Q) is a probability difference. Note that a value of the difference D_{L}(L′, O, Q) becomes a positive value, a negative value, or zero. Note that the difference D_{L}(L′, O, Q) is an example of the score.

### [Example of Inference]

No limitations are imposed on an optimization problem related to processing of each of the example embodiments in the present invention and on inference for use in the optimization problem. However, examples of the optimization problem for use in inference and a parameter thereof will be described as a reference for explanation of each of the example embodiments.

### (1) First Optimization Problem

A first optimization problem is as follows.
minimize Card(L′)
subject to D_{L}(L′, O, Q)≤ε
In this case, a parameter ε is a parameter that determines an upper limit of the difference D_{L}(L′, O, Q).

The first optimization problem is a problem of calculating a rule subset L′ with the least number of rules F among rule subsets L′ in which the difference D_{L}(L′, O, Q) is equal to or lower than the parameter ε.

When the score is the difference D_{L}(L′, O, Q), the parameter ε becomes a parameter that determines the upper limit of the score.

For example, when the inference system 100 to be described later sends the parameter ε to an optimization unit 310 that calculates a solution of the first optimization problem, the inference system 100 acquires the rule subset L′ as the solution of the first optimization problem from the optimization unit 310.

### (2) Second Optimization Problem

A second optimization problem is as follows.
minimize D_{L}(L′, O, Q))
subject to Card(L′)≤C
In this case, a parameter C is a parameter that determines an upper limit of the number of elements (number of rules F) included in the rule subset L′.

The second optimization problem is a problem of calculating a rule subset L′ in which the difference D_{L}(L′, O, Q) is minimized among rule subsets L′ in which the number of rules F is equal to or smaller than the parameter C.

When the score is the number of elements (Card(L′)) of the rule subset L′, the parameter C becomes a parameter that determines the upper limit of the score.

For example, when the inference system 100 to be described later sends the parameter C to the optimization unit 310 that calculates a solution of the second optimization problem, the inference system 100 acquires the rule subset L′ as the solution of the second optimization problem from the optimization unit 310.

### First Example Embodiment

Hereinafter, a description will be given to a first example embodiment in the present invention with reference to the drawings.

The inference system 100 according to the first example embodiment visualizes the rule subset L′ that is a solution of a predetermined optimization problem.

However, as already described above, no particular limitations are imposed on the optimization problem to which the inference system 100 is related and the inference for use therein. For example, the inference system 100 may visualize an optimal solution of the above-described first optimization problem or second optimization problem. In this case, for example, as described below, the inference system 100 receives a parameter, transmits the parameter to the optimization unit 310, acquires the rule subset L′ from the optimization unit 310, and visualizes the rule subset L′.

### [Explanation of Configuration]

A description will be given to a configuration of the inference system 100 according to the first example embodiment in the present invention with reference to the drawings.

First, an outline of the inference system 100 will be described by using an information processing system 300 including the inference system 100.

FIG. 13 is a block diagram illustrating an example of a configuration of the information processing system 300 including the inference system 100. The information processing system 300 includes the inference system 100 and the optimization unit 310.

The inference system 100 transmits, to the optimization unit 310, a parameter for use in optimization processing in the optimization unit 310.

By using the parameter, the optimization unit 310 calculates an optimal solution of an optimization problem related to a predetermined inference. For example, the optimization unit 310 selects (or calculates) the rule subset L′ as an optimal solution of an optimization problem related to an inference to the query Q from the observation O and the rule set L. Then, the optimization unit 310 transmits the rule subset L′ to the inference system 100.

Then, the inference system 100 visualizes the rule subset L′.

For example, the inference system 100 receives a parameter from a device operated by the user, and visualizes a rule subset L′ associated with the parameter.

As described above, the inference system 100 is related to the inference from the observation O and the rule set L to the query Q.

Next, the inference system 100 will be described with reference to the drawing.

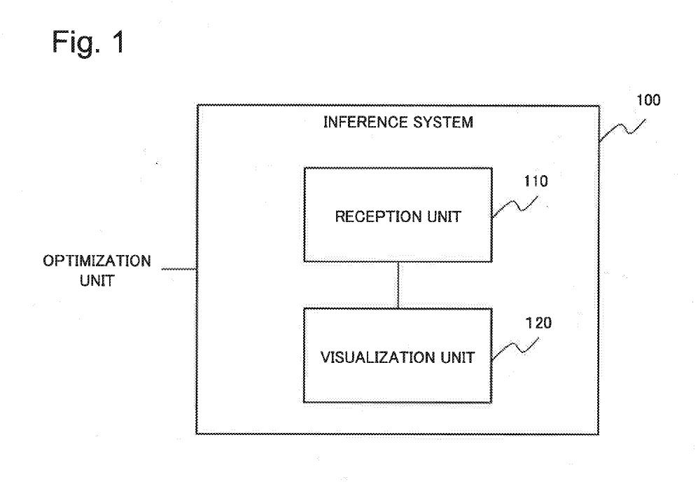

FIG. 1 is a block diagram illustrating an example of a configuration of the inference system 100 according to the first example embodiment. As illustrated in FIG. 1, the inference system 100 includes a reception unit 110 and a visualization unit 120.

The reception unit 110 receives a parameter for the visualization from a predetermined device or system. The parameter is information related to a score used when the optimization unit 310 processes an optimization problem. For example, the parameter is a value that designates a range of the score, that is, a value for use in selection (or calculation) of the rule subset L′. A specific example of the parameter is the parameter ε of the above-described first optimization problem or the parameter C of the above-described second optimization problem.

The visualization unit 120 acquires the rule subset L′ related to the parameter, and visualizes the rule subset L′. In other words, the visualization unit 120 visualizes the rule subset L′ associated with the parameter.

Operations of the visualization unit 120 will be described in more detail. As an example, a description will be given to a case in which the visualization unit 120 visualizes the rule subset L′ associated with the parameter ε in the first optimization problem. In this case, the parameter ε is a value related to the above-described comparison result (the difference D_{L}(L′, O, Q), for example). Note that in a case of the second optimization problem, the parameter C becomes a value related to the number of rules F.

First, the reception unit 110 receives the parameter ε. The reception unit 110 transmits the received parameter ε to the visualization unit 120. Then, the visualization unit 120 transmits the parameter ε to the optimization unit 310.

By using the parameter ε, the optimization unit 310 calculates the rule subset L′ as the optimal solution of the first optimization problem, and then transmits the calculated rule subset L′ to the visualization unit 120. In this processing, for example, the optimization unit 310 calculates a probability (first inference result) at which the query Q is established from the observation O and the rule set L, and a probability (second inference result) at which the query Q is established from the observation O and the rule subset L′. Then, the optimization unit 310 calculates the difference D_{L}(L′, O, Q) based on the first inference result and the second inference result. Then, the optimization unit 310 determines the rule subset L′ based on the differences D_{L}(L′, O, Q).

The visualization unit 120 acquires the rule subset L′ that is the optimal solution from the optimization unit 310.

However, it is not necessary that operations of the inference system 100 to be simultaneous with operations in the optimization unit 310.

For example, when the rule subset L′ associated with each parameter ε is previously stored in a storage unit, not illustrated, the visualization unit 120 may acquire the rule subset L′ associated with the parameter ε from among the stored rule subsets L′.

Then, the visualization unit 120 visualizes the rule subset L′ associated with the parameter ε. Further, the visualization unit 120 may visualize information related to the rule subset L′. For example, the visualization unit 120 may visualize the parameter ε in relation to the rule subset L′. Further, the visualization unit 120 may visualize a score of the rule subset L′.

The operations of the visualization unit 120 will be described with reference to the drawings.

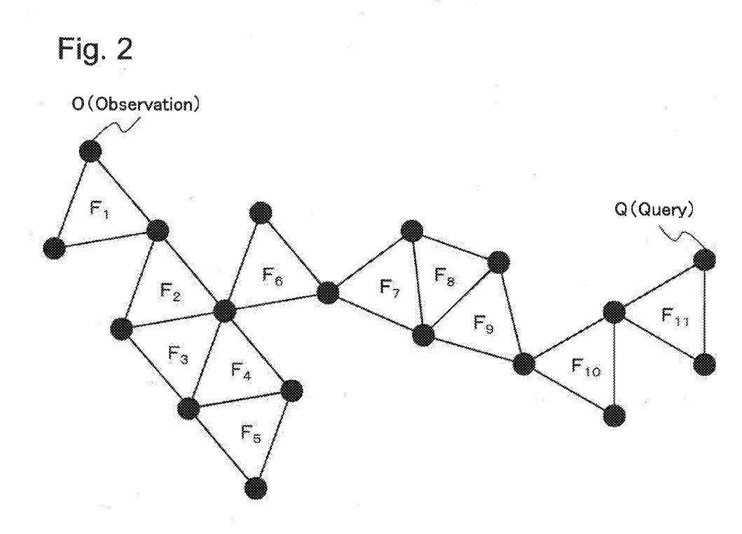

FIG. 2 is a diagram illustrating a first example of the rule set L for use in the following explanation. FIG. 2 is a diagram displaying the rule set L as an undirected graph. The undirected graph illustrated in FIG. 2 is a graph that expresses the rule set L as follows. First, ground atoms included in the rule set L are defined as nodes (black circles in FIG. 2). Next, links (segments in FIG. 2) are generated between ground atoms which appear in the same rule F. However, graphs for the rule set L and the rule subset L′ used by the inference system 100 are not limited to the graph illustrated in FIG. 2. The inference system 100 may use another graph such as a directed graph.

In FIG. 2, each triangle indicates one rule F. In other words, the rule set L illustrated in FIG. 2 includes rule F₁ to rule F₁₁. Note that the rule set L is a rule subset L′ when “ε=0.0”. In other words, FIG. 2 is also a diagram illustrating an example of the rule subset L′.

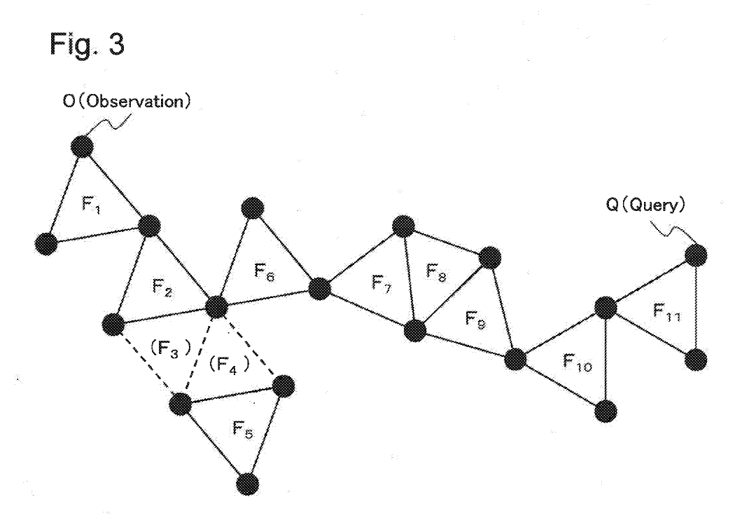

FIG. 3 is a diagram illustrating an example of a rule subset L′ for a predetermined parameter ε (ε=0.4, for example).

In FIG. 3, the visualization unit 120 illustrates an excluded rule F by using broken lines. In other words, the rule subset L′ illustrated in FIG. 3 is a rule subset L′ excluding a rule F₃ and rule F₄. In this case, an excluded rule subset L″ is {F₃, F₄}.

As described above, in FIG. 3, the visualization unit 120 visualizes the rule subset L′ in such a way as to visualize a difference between the rule set L and the rule subset L′ (that is, the excluded rule set L″).

However, this is an example of visualization of the excluded rule F in the visualization unit 120. The visualization unit 120 does not need to visualize the excluded rule F. Alternatively, the visualization unit 120 may visualize the excluded rule F by using a different color or shape from that of other rules F.

In the rule subset L′ illustrated in FIG. 3, the rules F are connected to one another from the observation O to the query Q. In other words, the rule subset L′ includes a route (first route) that traces from the observation O to the query Q. As described above, when the route from the observation O to the query Q is included in the rule subset L′, the visualization unit 120 can visualize the rule F included in the route from the observation O to the query Q.

Note that the visualization unit 120 does not need to visualize the rule F separated from the route. For example, in FIG. 3, the rule F₅ is separated from the route from the observation O to the query Q. Therefore, the visualization unit 120 does not need to visualize the rule F₅. When operating as described above, the visualization unit 120 can visualize the rule F having high relevance to an inference process or a reason.

Here, in FIG. 3, the rule F₅ is separated from the rule subset L′. Therefore, the rule F₅ is substantially excluded from the rule subset L′. In other words, the rule subset L′ in FIG. 3 is a set of the rules F excluding the rules F₃, F₄, and F₅.

Then, “0.4” as a value of the parameter ε is a somewhat large value as the difference D_{L}. In other words, the rule subset L′ illustrated in FIG. 3 is a set of rules F which remain even when the value of the parameter ε becomes somewhat large. Meanwhile, the rules F₃ and F₄ (and F₅) are rules F excluded according to the parameter ε.

As described above, based on a display of FIG. 3, the inference system 100 indicates a dependent degree (dependence) of the rule F in the inference from the observation O to the query Q. Specifically, the inference system 100 visualizes that the rule F included in the rule subset L′ (rules F₆ and F₇, for example) has higher dependence in comparison with the excluded rule F (rules F₃ and F₄, for example).

Note that, as described above, “0.4” as the value of the parameter ε is a somewhat large value as the difference D_{L}. Therefore, even when a somewhat large difference is permitted, the inference system 100 visualizes that the observation O and the query Q are connected to each other, that is, a dependent relationship between the observation O and the query Q is large.

As a result, based on the parameter ε, the user can confirm that the dependent relationship between the observation O and the query Q is large. Further, the user can confirm that the rule F included in the rule subset L′ has higher dependence in comparison with the excluded rule F.

As described above, the inference system 100 can visualize, for the user and the like, the dependent relationship between the observation O and the query Q by using the visualized rule subset L′.

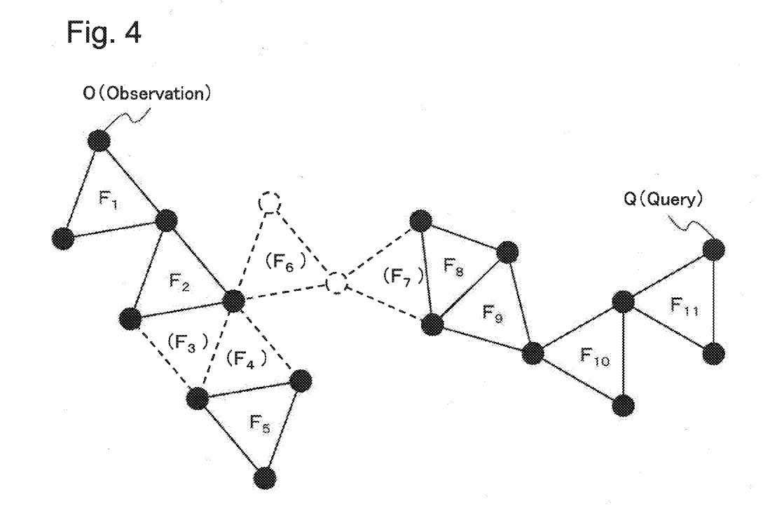

FIG. 4 is a diagram illustrating an example of a rule subset L′ for a parameter ε (ε=0.5, for example) different from that in FIG. 3.

In the rule subset L′ illustrated in FIG. 4, the rules F₆ and F₇ are excluded in addition to the rules F excluded in FIG. 3. As a result, in the rule subset L′, the route from the observation O to the query Q is disconnected. In other words, the rule subset L′ in FIG. 4 does not include the route that can trace from the observation O to the query Q. As described above, the inference system 100 can indicate that the route is disconnected in a predetermined parameter and can indicate the disconnected rules F.

When the route is disconnected as in FIG. 4, the visualization unit 120 visualizes at least a route (second route) from the observation O to a rule F on a terminal end along an orientation toward the query Q or a route (third route) from the query Q to a rule F on a terminal end along an orientation toward the observation O. In FIG. 4, the second route is a route from the observation O to the rule F₂. Further, the third route is a route from the rule F₈ to the query Q.

Note that the visualization unit 120 may visualize both of the second route and the third route as illustrated in FIG. 4, or may visualize either one thereof. Further, when the rule subset L′ includes a route divided into more than two portions, the visualization unit 120 may visualize a partial route or the entire route.

Referring to FIG. 3 and FIG. 4, the user can confirm that rules F connected through to the last are the rules F₆ and F₇ in the route from the observation O to the query Q. As described above, the inference system 100 can indicate, to the user and the like, the rules F (rules F₆ and F₇ in FIG. 4) connected through to the last in the route from the observation O to the query Q. In other words, the inference system 100 can indicate, to the user and the like, the rules F disconnected first in the route from the observation O to the query Q.

Referring to FIG. 3 and FIG. 4, it can be confirmed that the route from the observation O to the query Q is disconnected at a numerical value of the parameter ε which ranges from 0.4 to 0.5.

Further, when the value of the parameter ε is 0.4, the rules F₃ and F₄ are excluded, and when the value of the parameter ε is 0.5, the rules F₆ and F₇ are excluded. From this, the user can confirm that the dependence of the rules F₆ and F₇ is higher than the dependence of the rules F₃ and F₄ in the inference from the observation O to the query Q.

As described above, the inference system 100 can indicate, to the user and the like, a magnitude of the dependent relationship between the observation O and the query Q in association with the rules F.

Further, in order to indicate the above-described contents, the inference system 100 may execute the visualization (display) of the rule set L and/or the rule subset L′ as follows.

Note that, in the following description, it is assumed that the inference system 100 includes a display instrument and an input instrument, neither being illustrated. Specifically, it is assumed that the inference system 100 includes a touch panel, not illustrated, as an example of the display instrument and the input instrument.

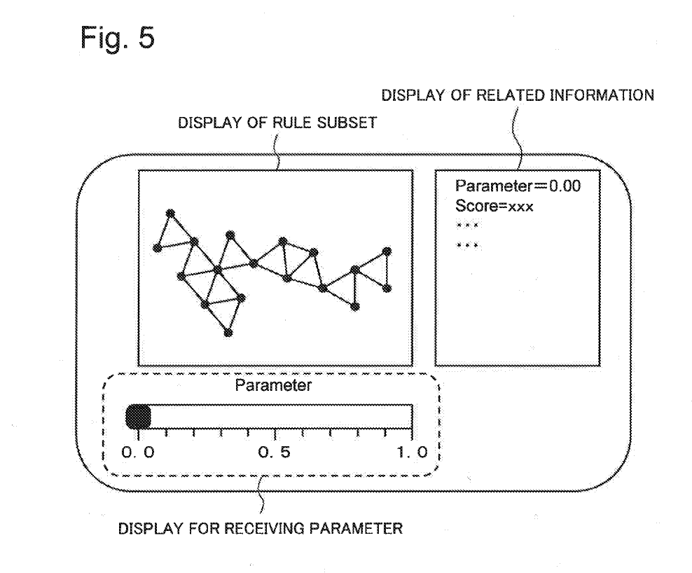

FIG. 5 is a view illustrating an example of the visualization of the rule set L.

On the display instrument, the inference system 100 displays a display for receiving the parameter ε and the rule subset L′ associated with the parameter ε. In addition to the above, the inference system 100 may display information related thereto (a value of the parameter ε and a value of the score, for example).

An upper left portion in FIG. 5 is a display of the rule subset L′. Note that FIG. 5 is a display when the value of the parameter ε is “0.0”. Therefore, the rule subset L′ is the rule set L.

A lower portion in FIG. 5 is a display for receiving the parameter ε. In FIG. 5, the user sets the value of the parameter ε by using a scroll bar indicating a range from 0.0 to 1.0. For example, since the touch panel is used in this description, the user just needs to touch a desired position of the scroll bar. The reception unit 110 of the inference system 100 transmits, to the visualization unit 120, a value of the parameter ε which associates with the position of the touch panel. Then, the visualization unit 120 displays the rule subset L′ associated with the parameter ε.

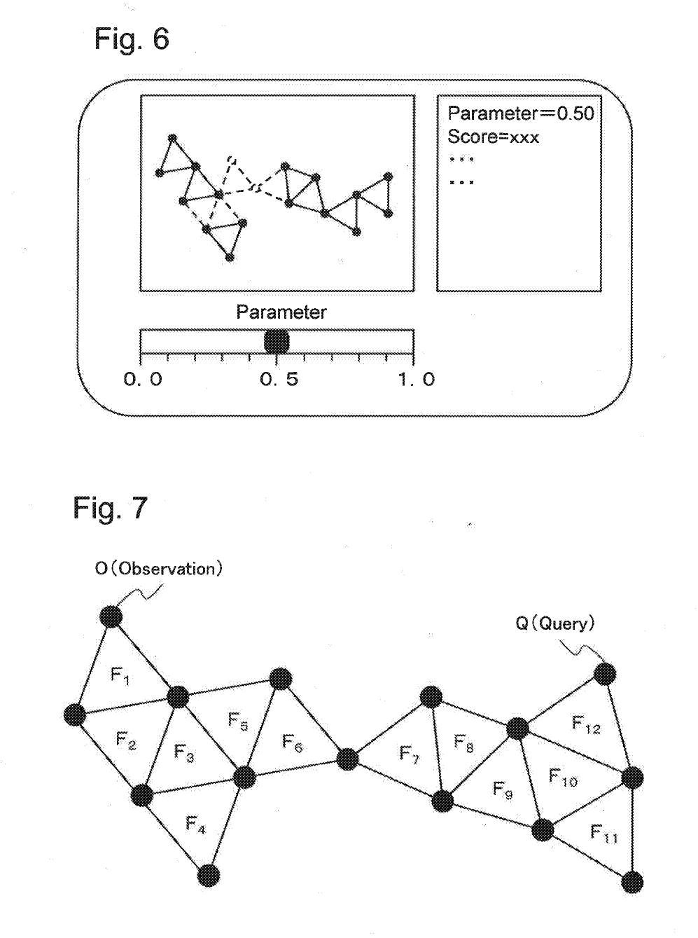

FIG. 6 is a view illustrating an example of the visualization in a case of a predetermined parameter value (ε=0.5). As illustrated in FIG. 6, when the user touches a position of “0.5” on the scroll bar, the inference system 100 displays the rule subset L′ in that case.

As described above, the reception unit 110 acquires information associated with the set value for the parameter ε, the value for a settable range of the parameter ε. Specifically, the information associated with the value of the parameter ε is information on the position of the scroll bar.

Next, visualization in a case of another rule set L will be described with reference to FIGS. 7 to 9.

FIG. 7 is a diagram illustrating a second example of the rule set L for use in the following explanation.

The rule set L illustrated in FIG. 7 includes the rule F₁ to a rule F₁₂. Note that the rule set L is the rule subset L′ in the case of “ε=0.0”.

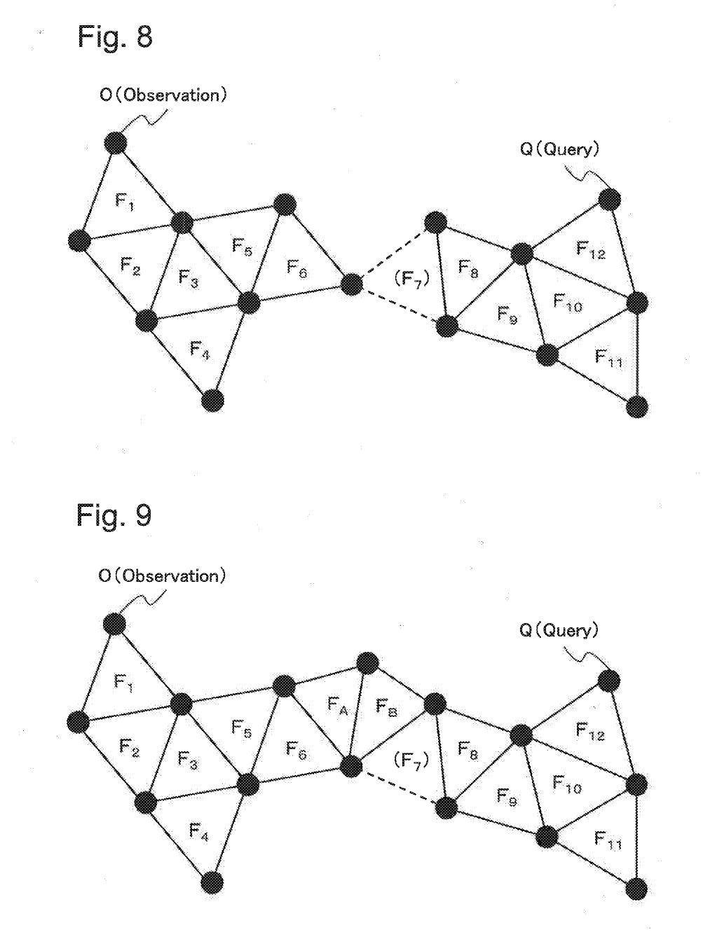

FIG. 8 is a diagram illustrating an example of a rule subset L′ for a predetermined parameter ε (ε=0.01, for example) in the second example of the rule set L.

The rule subset L′ illustrated in FIG. 8 is a rule subset L′ excluding the rule F₇. As a result, in the rule subset L′, the route from the observation O to the query Q is disconnected at a position of the rule F₇. In other words, the rule subset L′ in FIG. 8 does not have the route from the observation O to the query Q.

Here, “0.01” as a value of the parameter ε is a fairly small value. Therefore, referring to FIG. 8, the user can confirm that the dependent relationship between the observation O and the query Q is small. Further, the user can confirm that it is necessary to add a rule F at the position of the excluded rule F₇ in order to increase the dependent relationship.

As described above, the inference system 100 can indicate, to the user and the like, that the dependent relationship between the observation O and the query Q is small. Further, the inference system 100 can indicate, to the user and the like, the position of the rule F required for increasing the dependent relationship (rule F₇ in FIG. 8). As a result, the user and the like can easily add the rule F for increasing the dependent relationship.

FIG. 9 is a diagram illustrating an example of a rule F to be added to the second example of the rule set L. However, in FIG. 9, in order to facilitate understanding, a display of the rule F₇ excluded in FIG. 8 is set similar to that in FIG. 8.

In FIG. 9, a rule F_{A} and a rule F_{B} are added. As a result, the route from the observation O to the query Q continues even when the rule F₇ is excluded.

In the description so far, the example of the case in which the visualization unit 120 executes the visualization associated with each of the parameters has been described. However, a technique of the visualization in the visualization unit 120 is not limited to that described above. For example, the visualization unit 120 may execute visualization associated with a plurality of parameters.

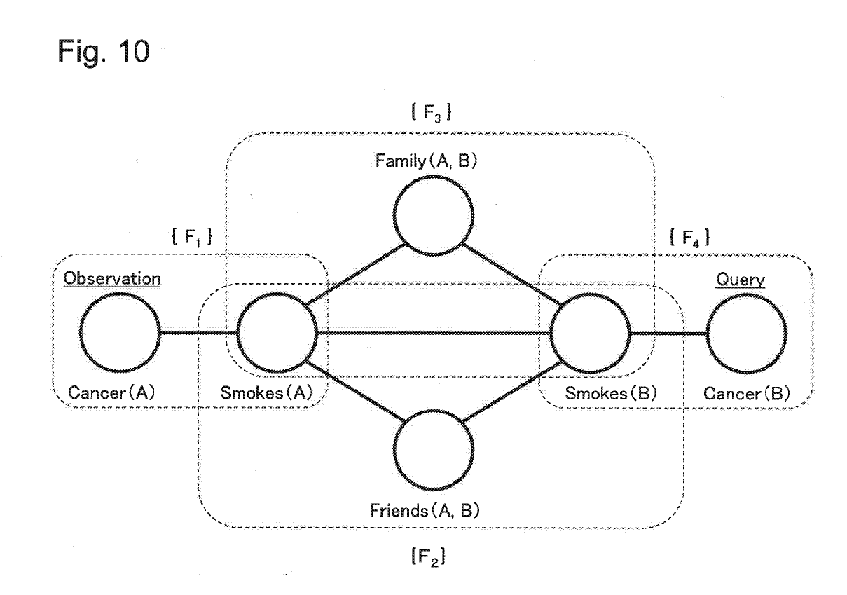

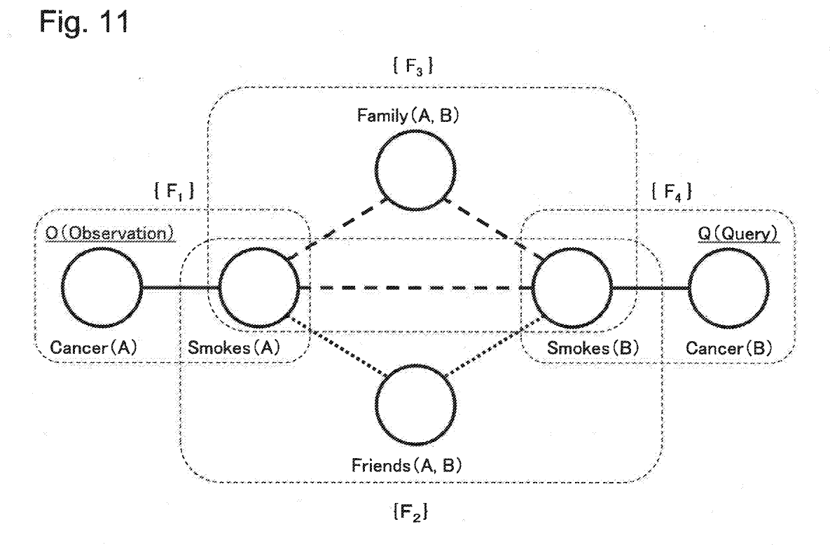

Another visualization of the visualization unit 120 will be described with reference to FIG. 10 and FIG. 11.

FIG. 10 is a diagram illustrating a third example of the rule set L for explaining another visualization.

The rule set L illustrated in FIG. 10 includes four rules (rule F₁ to F₄). Atoms and the rules F, which are illustrated in FIG. 10, are as follows.

### (1) Atoms (X and Y are Variables in the Following Description)

Cancer (X): X has cancer.
Smokes (X): X smokes.
Family (X, Y): X and Y are a family.
Friends (X, Y): X and Y are friends.

### (2) Rules F

F₁: If A smokes, then A has cancer.
F₂: If A smokes, and if A and B are friends, then B smokes.
F₃: If A smokes, and if A and B are a family, then B smokes.
F₄: If B smokes, then B has cancer.

Here, it is assumed that the visualization unit 120 uses two parameters ε(ε₁<ε₂).

FIG. 11 is a diagram illustrating an example of visualization dealing with a plurality of parameters.

In FIG. 11, the rule F₂ shown by a dotted line is a rule F excluded in a case of the parameter ε₁. In other words, in the case of the parameter ε₁, the rule F₂ is excluded.

The rule F₃ shown by a broken line is a rule F excluded in a case of the parameter ε₂. The parameter ε₂ is larger than the parameter ε₁. Therefore, the rule F₂ shown by the dotted line is excluded also in the case of the parameter ε₂. In other words, in the case of the parameter ε₂, the rules F₂ and F₃ are excluded.

The rule F₁ and the rule F₄, which are shown by solid lines, are rules F which are not excluded even in the parameter ε₂.

As described above, the visualization unit 120 may visualize the rules F in association with the plurality of parameters.

Note that a technique of the visualization to be used by the visualization unit 120 is not limited to that described above. For example, the visualization unit 120 may use such a visualization technique that is proportional or inversely proportional to the value of the parameter. Here, the technique that is proportional or inversely proportional to the value of the parameter is, for example, a technique of setting a density (gray gradation) of an image for use in the visualization along the value of the parameter, or a technique of changing a color for use in the visualization along the value of the parameter.

Further, the inference system 100 may use layered rule sets L. In this case, the visualization unit 120 may change layers to be visualized, based on a predetermined instruction (an instruction from the user, for example).

### [Explanation of Operations]

Next, a description will be given to the operations of the inference system 100 according to the first example embodiment with reference to the drawing.

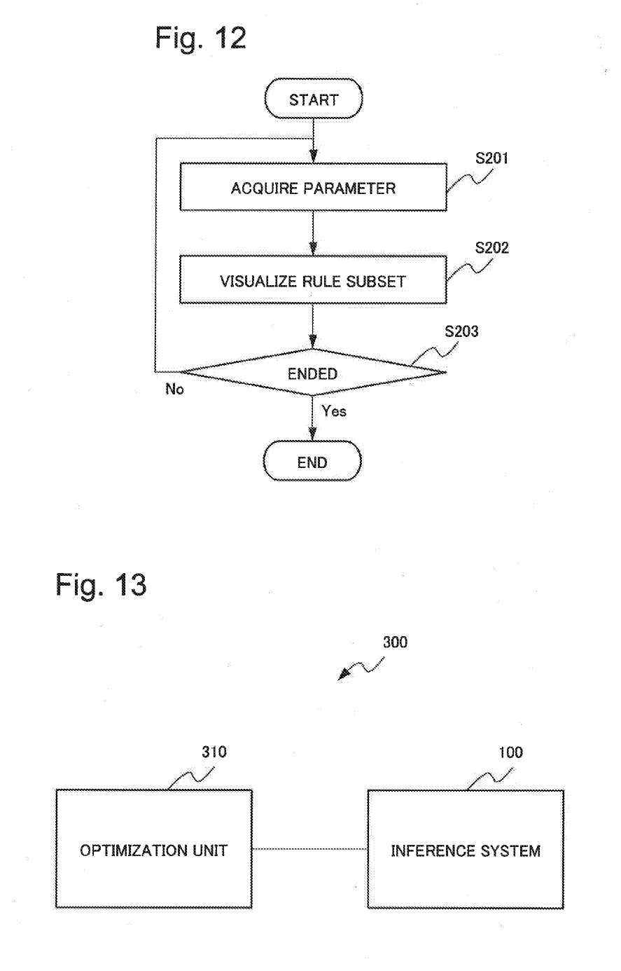

FIG. 12 is a flowchart illustrating an example of the operations of the inference system 100.

First, the reception unit 110 receives the parameter (Step S201).

The visualization unit 120 acquires the rule subset L′ based on the parameter, and visualizes the acquired rule subset L′ (Step S202). For example, by using such a display as in FIG. 6, the visualization unit 120 visualizes the rule subset L′.

Then, the visualization unit 120 determines whether or not to end the operations of the visualization (Step S203). For example, the visualization unit 120 receives an instruction to end or continue the operations from a device, not illustrated, operated by the user, and determines whether or not to end the visualization operations.

When the visualization operations are to be ended (Yes in Step S203), the inference system 100 including the visualization unit 120 ends the operations.

When the visualization operations are not to be ended (No in Step S203), the inference system 100 returns to Step S201. In this case, the reception unit 110 receives a next parameter, and the inference system 100 repeats the above-described operations.

Note that the inference system 100 may operate to return to Step S201 after Step S202. In other words, the inference system 100 may operate continuously without ending the operations.

### [Explanation of Effects]

A description will be given to effects of the inference system 100 according to the first example embodiment.

As described above, the inference system 100 according to the first example embodiment can exhibit an effect of presenting an inference process or a reason.

A reason for the above is as follows.

The reception unit 110 receives the parameter (parameter ε, for example) for use in selecting the rule subset L′ from the rule set L.

Then, the visualization unit 120 acquires the rule subset L′ associated with the parameter, and visualizes the rule subset L′.

Here, the optimization unit 310 selects (or calculates) the rule subset L′ as the optimal solution of the optimization problem of optimizing the inference from the observation O to the query Q. Further, the parameter is a value related to the selection of the rule subset L′ in the optimization unit 310.

Then, the rule subset L′ is information indicating a relation of at least a part of the rules F in the route from the observation O to the query Q. In other words, the rule subset L′ is information related to the inference process or the reason.

In other words, the visualization unit 120 visualizes the rule subset L′ that is the information related to the inference process or the reason.

As described above, the visualization unit 120 can visualize the rule subset L′ that is presentation of the inference process or the reason.

Further, the inference system 100 exhibits a following effect.

The inference system 100 visualizes the rule subset L′ associated with the received parameter. Further, the inference system 100 visualizes the rule subset L′ associated with the plurality of parameters. For example, as described with reference to FIG. 3 and FIG. 4, the inference system 100 can visualize a case in which the value of the parameter ε is “0.4”, that is the case in which the route is included in the rule subset L′, and a case in which the value of the parameter ε is “0.5”, that is the case in which the route is not included. As described above, for the received parameter, the inference system 100 can visualize “whether or not the route from the observation O to the query Q is included in the rule subset L′”.

Hence, the inference system 100 exhibits an effect of being capable of indicating the dependent relationship between the observation O and the query Q to the user and the like.

Further, the inference system 100 can visualize the rule subset L′ associated with the plurality of parameters. In other words, the inference system 100 can visualize at what value of the parameter “causes to disconnect the route from the observation O to the query Q in the rule subset L′”.

Hence, the inference system 100 exhibits an effect of being capable of indicating a degree of the dependent relationship between the observation O and the query Q to the user and the like.

Further, the inference system 100 can visualize the rule subset L′ associated with the plurality of parameters. In other words, the inference system 100 can visualize the rule F to be excluded in association with each of the parameters.

Hence, the inference system 100 exhibits an effect of being capable of indicating, to the user and the like, the dependent degree (the dependence) of the rule F in the inference from the observation O to the query Q. In detail, the inference system 100 exhibits an effect of being capable of indicating, to the user and the like, a rule F with high dependence and a rule F with low dependence in the inference from the observation O to the query Q.

### [Hardware Configuration]

A hardware configuration of the inference system 100 will be described.

The inference system 100 is configured as follows.

A part or all of the respective elements of the inference system 100 are implemented using a general-purpose or dedicated circuitry, a processor and the like, or a combination of these. These may be configured using a single chip, or may be configured using a plurality of chips connected to one another via a bus. A part or all of the respective elements of the inference system 100 may be implemented using a combination of the above-mentioned circuitry and the like, and a program.

When a part or all of the respective elements of the inference system 100 are implemented by using a plurality of information processing apparatuses, circuitries, or the like, the plurality of information processing apparatuses, the circuitries, or the like may be arranged centrally, or may be distributed. For example, the information processing apparatuses, the circuitries, or the like may be implemented as a configuration in which the respective elements are connected to one another via a communication network, such as a client and server system, a cloud computing system, or the like.

Further, in the inference system 100, a plurality of constituent units may be implemented by a single piece of hardware.

Further, the inference system 100 may be implemented as a computer apparatus including a central processing unit (CPU), a read only memory (ROM), and a random access memory (RAM). The inference system 100 may be implemented as a computer apparatus further including an input/output circuit (IOC) and a network interface circuit (NIC) in addition to the above-described configuration.

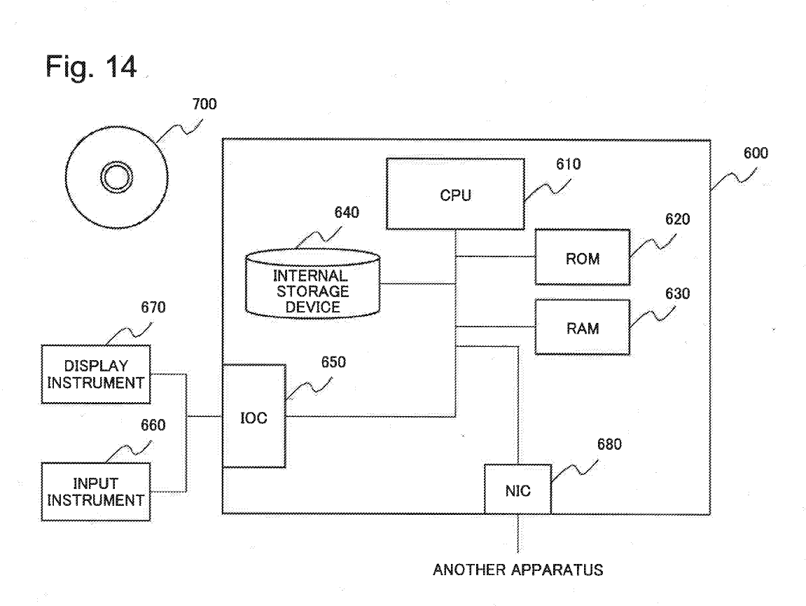

FIG. 14 is a block diagram illustrating a configuration of an information processing apparatus 600 that is an example of the configuration of the hardware according to the inference system 100.

The information processing apparatus 600 includes a CPU 610, a ROM 620, a RAM 630, an internal storage device 640, an IOC 650, and an NIC 680, and configures a computer apparatus.

The CPU 610 reads a program from the ROM 620. Then, based on the read program, the CPU 610 controls the RAM 630, the internal storage device 640, the IOC 650, and the NIC 680. Then, the computer including the CPU 610 controls these constituents, and implements respective functions as the inference system 100 (reception unit 110 and visualization unit 120) illustrated in FIG. 1 and FIG. 13. Further, the computer including the CPU 610 may control these constituents, and may implement a function as the optimization unit 310 illustrated in FIG. 13.

At a time of implementing the respective functions, the CPU 610 may use the RAM 630 or the internal storage device 640 as a temporal storage medium of the program.

Further, using a storage medium reading device, not illustrated, the CPU 610 may read a program included in a storage medium 700 that stores the program in such a way as to be readable by a computer. Alternatively, the CPU 610 may receive a program from an external device, not illustrated, via the NIC 680, store the received program in the RAM 630 or the internal storage device 640, and operate based on the stored program.

The ROM 620 stores the program and fixed data, which are executed by the CPU 610. For example, the ROM 620 is a programmable-ROM (P-ROM) or a flash ROM.

The RAM 630 temporarily stores the program and the data, which are executed by the CPU 610. For example, the RAM 630 is a Dynamic-RAM (D-RAM). The RAM 630 may store the parameter and/or the rule subset L′. Further, the RAM 630 may store the observation O and/or the query Q.

The internal storage device 640 stores data and a program, which the information processing apparatus 600 stores for a long term. Further, the internal storage device 640 may operate as a temporal storage device of the CPU 610. For example, the internal storage device 640 is a hard disk device, a magneto-optical disk device, a solid state drive (SSD), or a disk array device. The internal storage device 640 may store the parameter and/or the rule subset L′. The internal storage device 640 may store the observation O and/or the query Q. The internal storage device 640 may further store the rule set L or the optimization problem to be processed by the optimization unit 310.

Here, the ROM 620 and the internal storage device 640 are non-transitory recording media. Meanwhile, the RAM 630 is a transitory recording medium. Further, the CPU 610 is operable based on the program stored in the ROM 620, the internal storage device 640, or the RAM 630. In other words, the CPU 610 is operable by using the non-transitory recording medium or the transitory recording medium.

The IOC 650 relays the data between the CPU 610, and input instrument 660 and display instrument 670. For example, the IOC 650 is an IO interface card or a universal serial bus (USB) card. Further, the IOC 650 may use not only a wired instrument such as the USB but also a wireless instrument.

The input instrument 660 is an instrument that receives an input instruction from an operator of the information processing apparatus 600. The input instrument 660 is a keyboard, a mouse, or a touch panel, for example. The input instrument 660 may operate as a part of the reception unit 110. In this case, the input instrument 660 receives the parameter. Further, the input instrument 660 may receive the observation O, the query Q, and/or the rule set L.

The display instrument 670 is an instrument that displays information to the operator of the information processing apparatus 600. The display instrument 670 is a liquid crystal display, for example. The display instrument 670 may operate as a part of the visualization unit 120. In this case, the display instrument 670 displays the rule subset L′. Further, the display instrument 670 may display related information (parameter or score, for example) or a display (scroll bar, for example) for receiving the parameter.

The NIC 680 relays exchange of the data with an external device, not illustrated, via a network. The NIC 680 is a local area network (LAN) card, for example. Further, the NIC 680 may use not only a wired instrument but also a wireless instrument. The NIC 680 may operate as a part of the reception unit 110 and/or the visualization unit 120. In this case, the NIC 680 receives the parameter. Alternatively, the NIC 680 transmits the rule subset L′. Further, the NIC 680 may receive the observation O, the query Q, and/or the rule set L.

The information processing apparatus 600 configured as described above can acquire similar effects to those of the inference system 100.

A reason for this is that the CPU 610 of the information processing apparatus 600 can implement similar functions to those of the inference system 100 based on the program.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be applied to use of plainly explaining a reason of reaching an inference result of artificial intelligence in a support for human intellectual labor based on the artificial intelligence having a probabilistic logical inference technique at the core.

The present invention can be widely applied to a case of receiving an observation and a query as inputs, and calculating a posterior probability of the query under the observation by not only the inference technique such as MLN and PSL but also by a probabilistic logical inference technique that defines a random variable and performs inference based on a logical expression.

### REFERENCE SIGNS LIST

100 Inference system
110 Reception unit
120 Visualization unit
300 Information processing system
310 Optimization unit
600 Information processing apparatus
610 CPU
620 ROM
630 RAM
640 Internal storage device
650 IOC
660 Input instrument
670 Display instrument
680 NIC
700 Storage medium

1. An inference system related to inference from a starting state and a first rule set to an ending state, comprising:
a memory; and
at least one processor coupled to the memory,
the processor performing operations, the operations comprising:
receiving a parameter for use in selecting a second rule set from the first rule set; and
visualizing the second rule set associated with the parameter.

2. The inference system according to claim 1, wherein
the parameter is a parameter for selecting the second rule set by excluding one or a plurality of rules from the first rule set.

3. The inference system according to claim 1, wherein
the operations further comprises
visualizing a difference between the first rule set and the second rule set.

4. The inference system according to claim 1, wherein,
the operations further comprises
when a first route from the starting state to the ending state is disconnected in the second rule set, visualizing at least a second route tracing toward the ending state from the starting state to a terminal end rule or a third route tracing toward the starting state from the ending state to a terminal end rule.

5. The inference system according to claim 1, wherein
the operations further comprises
visualizing the second rule set in association with a plurality of the parameters.

6. The inference system according to claim 1, wherein
the operations further comprises
receiving the parameter by using information associated with a set value of the parameter, the value for a settable range of the parameter.

7. The inference system according to claim 1, wherein,
when a probability at which the ending state is established from the starting state and the first rule set is defined as a first inference result, and a probability at which the ending state is established from the starting state and the second rule set is defined as a second inference result,
the parameter is related to a comparison result between the first inference result and the second inference result.

8. The inference system according to claim 1, wherein
the parameter is related to a number of rules included in the second rule set.

9. (canceled)

10. An inference method for an inference system related to inference from a starting state and a first rule set to an ending state, the inference method comprising:
receiving a parameter for use in selecting a second rule set from the first rule set; and
visualizing the second rule set associated with the parameter.

11. A non-transitory computer-readable recording medium embodying a program, the program causing an inference system to performing a method, the inference system related to inference from a starting state and a first rule set to an ending state, the method comprising:
receiving a parameter for use in selecting a second rule set from the first rule set; and
visualizing the second rule set associated with the parameter.
